(19) United States
(12) Patent Application Publication
(10) Pub. No.: US 2015/0046518 A1
(43) Pub. Date: Feb. 12, 2015

(54) ELECTRONIC DEVICE CAPABLE OF NOTIFYING UPDATED CONTENTS OF WEBPAGE AND METHOD FOR NOTIFYING UPDATED CONTENTS OF WEBPAGE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: DAN CAO, Shenzhen (CN)

(21) Appl. No.: 14/455,030

(22) Filed: Aug. 8, 2014

(30) Foreign Application Priority Data
Aug. 9, 2013 (CN) 2013103465237

(51) Int. Cl. H04L 29/08

(52) U.S. Cl. CPC H04L 67/1097
USPC 709/203

(57) ABSTRACT

An updated contents notification method includes determining and storing a plurality of favorite websites. The method obtains contents of webpages corresponding to the stored favorite websites from a web server via a first communication unit, and determines whether the contents of webpages corresponding to the stored favorite websites have been updated.

The method further obtains the updated contents of the webpages when the contents have been updated, converts the obtained updated contents of the webpages to short message service (SMS) messages, and transmits the converted SMS messages to a mobile phone via a second communication unit, to notify each relevant webpage.

### CROSS-REFERENCE TO RELATED APPLICATIONS

This application claims priority to Chinese Patent Application No. 201310346523.7 filed on Aug. 9, 2013 in the China Intellectual Property Office, the contents of which are incorporated by reference herein.

### FIELD

The subject matter herein generally relates to data exchanges.

### BACKGROUND

A general packet radio service (GPRS) network is commonly employed by mobile phones to access external networks such as the Internet. A charge to user for GPRS usage is typically based on volume of data transferred.

### BRIEF DESCRIPTION OF THE DRAWINGS

Implementations of the present technology will now be described, by way of example only, with reference to the attached figures.

FIG. 1 is a block diagram of an embodiment of an electronic device.

FIG. 2 illustrates a flowchart of an embodiment of an updated contents notification method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

In general, the word “module,” as used herein, refers to logic embodied in hardware or firmware, or to a collection of software instructions, written in a programming language. The software instructions in the modules can be embedded in firmware, such as in an erasable programmable read-only memory (EPROM) device. The modules described herein can be implemented as either software and/or hardware modules and can be stored in any type of computer-readable medium or other storage device. The term “comprising” means “including, but not necessarily limited to”; it specifically indicates open-ended inclusion or membership in a so-described combination, group, series and the like.

Embodiments of the present disclosure will be described with reference to the accompanying drawings.

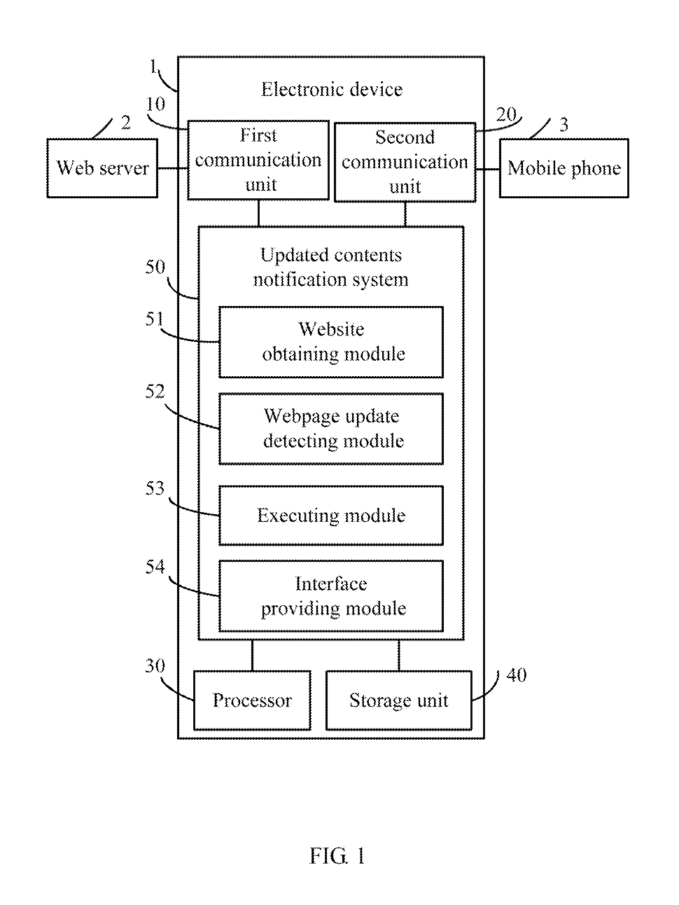

FIG. 1 shows an electronic device capable of notifying updated contents of webpage (hereinafter, electronic device 1). The electronic device 1 can include a first communication unit 10 and a second communication unit 20. The electronic device 1 can communicate with a web server 2 via the first communication unit 10, and can communicate with a mobile phone 3 via the second communication unit 20. In the embodiment, the first communication unit 10 enables the electronic device 1 to communicate with the web server 2 via Internet. The electronic device 1 can transmit a request for a website to the web server 2 in response to a user operation, and the web server 2 can receive the request for the target website from the electronic device 1 and deliver a webpage corresponding to the target website to the electronic device 1 according to the received request. In the embodiment, the second communication unit 20 enables the electronic device 1 to communicate with the mobile phone 3 via the global system for mobile communication (GSM) network, code division multiple access (CDMA) network, or wideband code division multiple access (WCDMA) network.

In at least one embodiment, the electronic device 1 can obtain updated contents of one or more webpages corresponding to one or more favorite websites via the first communication unit 10 when the contents of one or more webpages corresponding to the one or more favorite websites are updated. The electronic device 1 can further convert the obtained updated contents of the one or more webpages to one or more short message service (SMS) messages, and transmit the converted SMS messages to the mobile phone 3 via the second communication unit 20.

In at least one embodiment, the electronic device 1 includes a processor 30 and a storage unit 40. An updated contents notification system 50 is applied in the electronic device 1. In at least one embodiment, the updated contents notification system 50 can include a website obtaining module 51, a webpage update detecting module 52, and an executing module 53. One or more programs of the above function modules can be stored in the storage unit 40 and executed by the processor 30. The processor 30 can be a central processing unit, a digital signal processor, or a single chip, for example. The storage unit 40 can be a hard disk, a compact disk, or a flash memory, for example.

The website obtaining module 51 is configured to determine a number of favorite websites and store the determined favorite websites in the storage unit 40. The detail of a method whereby the website obtaining module 51 determines the number of favorite websites follows.

In a first embodiment, the website obtaining module 51 is configured to monitor accessing frequencies (number of times) of each website at predetermined intervals (e.g., every 10 days), and determine a number of favorite websites according to the monitored accessing frequencies of each website. In the embodiment, the website obtaining module 51 is configured to determine a first predetermined number of websites whose accessing frequencies are greater than a preset value, such as 10 times, and determine that the first predetermined number of websites are the favorite websites. In other embodiments, the website obtaining module 51 is configured to arrange the websites in a descending order according to the monitored accessing frequencies, determine a second predetermined number of websites whose accessing frequencies are greater than those of the rest of the websites, and determine that the second predetermined number of websites are the favorite websites.

In a second embodiment, the updated contents notification system 50 can include an interface providing module 54. The interface providing module 54 is configured to provide an interface for user input. The website obtaining module 51 is configured to set a website inputted in the interface as the favorite website each time, in response to the user operation in the interface.

In a third embodiment, the website obtaining module 51 is configured to receive SMS messages which contain one or more websites from the mobile phone 3 via the second communication unit 20, and recognize the one or more websites contained in each SMS message as the favorite websites. In the third embodiment, the user of the mobile phone 3 can edit one or more favorite websites into an SMS message and transmit the edited SMS message to the electronic device 1 via the second communication unit 20.

The webpage update detecting module 52 is configured to obtain contents of the webpages corresponding to the stored favorite websites from the web server 2 via the first communication unit 10, and determine whether the contents of one or more webpages corresponding to the stored one or more favorite websites have been updated according to the obtained contents of the webpages. In detail, the webpage update detecting module 52 is configured to obtain and store the contents of each webpage corresponding to each stored favorite website from the web server 2 via the first communication unit 10 when storing the favorite websites in the storage unit 40. The webpage update detecting module 52 is further configured to obtain the contents of the webpages corresponding to the stored favorite websites at predetermined time intervals, and compares the currently obtained contents of each webpage with the stored contents of the corresponding webpage. If one or more currently obtained contents of the webpages do not match the stored contents of the corresponding webpage, the webpage update detecting module 52 determines that the contents of the one or more webpages corresponding to the stored one or more favorite websites have been updated. In the embodiment, the webpage update detecting module 52 is further configured to substitute the updated contents of each of the one or more webpages for the corresponding stored contents of each of the corresponding webpages when the contents of one or more webpages corresponding to the stored favorite websites have been updated.

The executing module 53 obtains the updated contents of the one or more webpages, converts the obtained updated contents of the one or more webpages to one or more

SMS messages, and transmits the converted one or more SMS messages to the mobile phone 3 via the second communication unit 20. In the embodiment, the executing module 53 converts the obtained updated contents to one SMS message. In other embodiments, the executing module 53 converts the obtained updated contents into the same number of SMS messages as there are stored webpages to be updated.

In the embodiment, the executing module 53 is further configured to receive the SMS messages as feedback about the updated contents of the webpages via the second communication unit 20, and transmit the received SMS message to the web server 2 via the first communication unit 10, causing the web server 2 to apply the update to a corresponding webpage.

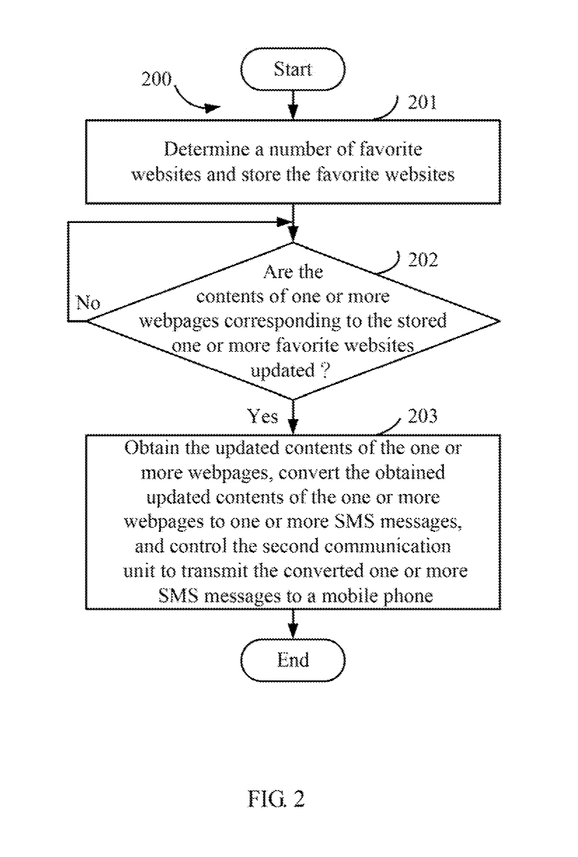

FIG. 2 illustrates a flowchart of an embodiment of an updated contents notification method 200. The method 200 is provided by way of example, as there are a variety of ways to carry out the method 200. The method 200 described below can be carried out using the configurations illustrated in FIG. 1, for example, and various elements of these figures are referenced in the explanation of method. Each block shown in FIG. 2 represents one or more processes, methods, or subroutines carried out in the method. Additionally, the illustrated order of blocks is by example only and the order of the blocks can change. The method 200 can begin at block 201.

In block 201, a website obtaining module determines a number of favorite websites and stores the determined favorite websites in the storage unit.

In a first embodiment, the website obtaining module monitors the accessing frequencies of each website at predetermined intervals, and determines a number of favorite websites according to the monitored accessing frequencies of each website. In the embodiment, the website obtaining module determines a first predetermined number of websites of which the accessing frequencies are greater than a preset value, such as 10 times, and determines that the first predetermined number of websites are the favorite websites. In other embodiments, the website obtaining module arranges the websites in a descending order according to the monitored accessing frequencies, determines a second predetermined number of websites whose accessing frequencies are greater than those of the rest of the websites, and determines that the second predetermined number of websites are the favorite websites.

In a second embodiment, an interface providing module provides an interface for user input. The website obtaining module sets a website inputted in the interface as a favorite website each time, in response to the user operation in the interface.

In a third embodiment, the website obtaining module receives SMS messages which contain one or more websites from the mobile phone via the second communication unit, and recognizes the one or more websites contained in each SMS message as the favorite websites. In the third embodiment, the user of the mobile phone can edit one or more favorite websites into an SMS message and transmit the edited SMS message to the electronic device via the second communication unit.

In block 202, a webpage update detecting module obtains contents of the webpages corresponding to the stored favorite websites from the web server via the first communication unit, and determines whether the contents of the one or more stored webpages has been updated according to the obtained contents of the webpages. If the contents of one or more webpages corresponding to the stored website have been updated, the procedure goes to block 203. If the content of none of the webpages corresponding to the stored favorite websites has been updated, the procedure goes to block 202. In detail, the webpage update detecting module obtains and stores the contents of the webpages corresponding to the stored favorite websites when storing the favorite websites in the storage unit 40. The webpage update detecting module further obtains the contents of the webpages corresponding to the stored favorite websites at predetermined time intervals, and compares the currently obtained contents of each webpage with the stored contents of the corresponding webpage. If one or more currently obtained contents of the webpages do not match the stored contents of the corresponding webpage, the webpage update detecting module determines that the contents of the one or more webpages corresponding to the stored one or more favorite websites have been updated.

In block 203, an executing module obtains the updated contents of the one or more webpages, converts the obtained updated contents of the one or more webpages to one or more

SMS messages, and controls the second communication unit to transmit the converted one or more SMS messages to the mobile phone.

In the embodiment, the webpage update detecting module further substitutes the updated contents of each of the one or more webpages for the corresponding stored contents of each of the corresponding webpages when the contents of one or more webpages corresponding to the stored favorite websites have been updated.

In the embodiment, the executing module further receives the SMS messages as feedback about the updated contents of the webpages via the second communication unit, and transmits the received SMS message to the web server via the first communication unit, causing the web server to apply the updated contents to a corresponding webpage.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. An electronic device capable of notifying updated contents of webpage comprising:
a first communication unit configured to enable the electronic device to communicate with a web server;
a second communication unit configured to enable the electronic device to communicate with a mobile phone;
a storage system;
a processor; and
one or more programs stored in the storage system and executed by the processor, the one or more programs comprising:
a website obtaining module configured to determine a plurality of favorite websites and store the determined favorite websites;
a webpage update detecting module configured to obtain contents of webpages corresponding to the stored favorite websites from the web server via the first communication unit, and to determine whether the contents of one or more webpages corresponding to the stored one or more favorite websites have been updated according to the obtained contents of the webpages; and
an executing module configured to obtain the updated contents of the one or more webpages, to convert the obtained updated contents of the one or more webpages to one or more short message service (SMS) messages, and to transmit the converted one or more SMS messages to the mobile phone via the second communication unit.

2. The electronic device as described in claim 1, wherein the website obtaining module is configured to:
monitor accessing frequencies of each website at predetermined intervals, determine a first predetermined number of websites whose accessing frequencies are greater than a preset value, or arrange the websites in a descending order according to the monitored accessing frequencies to determine a second predetermined number of websites whose accessing frequencies are greater than those of the rest of the websites, and determine that the first predetermined number of websites or the second predetermined number of websites are the favorite websites.

3. The electronic device as described in claim 1, further comprising an interface providing module, wherein:
the interface providing module is configured to provide an interface for user input; and
the website obtaining module is configured to set a website inputted in the interface as a favorite website each time in response to the user operation in the interface.

4. The electronic device as described in claim 1, wherein the website obtaining module is configured to receive SMS messages which contain one or more websites from the mobile phone via the second communication unit, and to recognize the one or more websites contained in each SMS message as the favorite websites.

5. The electronic device as described in claim 1, wherein the webpage update detecting module is configured to:
obtain and store the contents of each webpage corresponding to each stored favorite website from the web server via the first communication unit when storing the favorite websites;
obtain the contents of the webpages corresponding to the stored favorite websites at predetermined time intervals, and compare the currently obtained contents of each webpage with the stored contents of the corresponding webpage; and
determine that the contents of the one or more webpages corresponding to the stored one or more favorite websites have been updated when one or more currently obtained contents of the webpages do not match the stored contents of the corresponding webpage.

6. The electronic device as described in claim 1, wherein the executing module is further configured to receive the SMS messages as feedback about the updated contents of the webpages via the second communication unit, and to transmit the received SMS message to the web server via the first communication unit, causing the web server to apply the update to a corresponding webpage.

7. An updated contents notification method comprising:
determining a plurality of favorite websites and storing the determined favorite websites;
obtaining contents of webpages corresponding to the stored favorite websites from a web server via a first communication unit, and determining whether the contents of one or more webpages corresponding to the stored one or more favorite websites have been updated according to the obtained contents of the webpages; and
obtaining the updated contents of the one or more webpages, converting the obtained updated contents of the one or more webpages to one or more short message service (SMS) messages, and transmitting the converted one or more SMS messages to a mobile phone via a second communication unit.

8. The updated contents notification method as described in claim 7, wherein the method further comprises:
monitoring accessing frequencies of each website at predetermined intervals;
determining a first predetermined number of websites whose accessing frequencies are greater than a preset value, or arranging the websites in a descending order according to the monitored accessing frequencies to determine a second predetermined number of websites whose accessing frequencies are greater than those of the rest of the websites; and
determining that the first predetermined number of websites or the second predetermined number of websites are the favorite websites.

9. The updated contents notification method as described in claim 7, wherein the method further comprises:
providing an interface for user input; and
setting a website inputted in the interface as a favorite website each time in response to the user operation in the interface.

10. The updated contents notification method as described in claim 7, wherein the method further comprises:
receiving SMS messages which contain one or more websites from the mobile phone via the second communication unit, and recognizing the one or more websites contained in each SMS message as the favorite websites.

11. The updated contents notification method as described in claim 7, wherein the method further comprises:
obtaining and storing the contents of each webpage corresponding to each stored favorite website from the web server via the first communication unit when storing the favorite websites;
obtaining the contents of the webpages corresponding to the stored favorite websites at predetermined time intervals, and comparing the currently obtained contents of each webpage with the stored contents of the corresponding webpage; and
determining that the contents of the one or more webpages corresponding to the stored one or more favorite websites have been updated when one or more currently obtained contents of the webpages do not match the stored contents of the corresponding webpage.

12. The updated contents notification method as described in claim 7, wherein the method further comprises:
receiving the SMS messages as feedback about the updated contents of the webpages via the second communication unit, and transmitting the received SMS message to the web server via the first communication unit, causing the web server to apply the update to a corresponding webpage.

13. A non-transitory storage medium storing a set of instructions, the set of instructions capable of being executed by a processor of an electronic device, causing the electronic device to perform an updated contents notification method, the method comprising:
determining a plurality of favorite websites and storing the determined favorite websites;
obtaining contents of webpages corresponding to the stored favorite websites from a web server via a first communication unit, and determining whether the contents of one or more webpages corresponding to the stored one or more favorite websites have been updated according to the obtained contents of the webpages; and
obtaining the updated contents of the one or more webpages, converting the obtained updated contents of the one or more webpages to one or more short message service (SMS) messages, and transmitting the converted one or more SMS messages to a mobile phone via a second communication unit.

14. The non-transitory storage medium as described in claim 13, wherein the method further comprises:
monitoring accessing frequencies of each websites at predetermined intervals;
determining a first predetermined number of websites whose accessing frequencies are greater than a preset value, or arranging the websites in a descending order according to the monitored accessing frequencies to determine a second predetermined number of websites whose accessing frequencies are greater than those of the rest of the websites; and
determining that the first predetermined number of websites or the second predetermined number of websites are the favorite websites.

15. The non-transitory storage medium as described in claim 13, wherein the method further comprises:
providing an interface for user input; and
setting a website inputted in the interface as a favorite website each time in response to the user operation in the interface.

16. The non-transitory storage medium as described in claim 13, wherein the method further comprises:
receiving SMS messages which contain one or more websites from the mobile phone via the second communication unit, and recognizing the one or more websites contained in each SMS message as the favorite websites.

17. The non-transitory storage medium as described in claim 13, wherein the method further comprises:
obtaining and storing the contents of each webpage corresponding to each stored favorite website from the web server via the first communication unit when storing the favorite websites;
obtaining the contents of the webpages corresponding to the stored favorite websites at predetermined time intervals, and comparing the currently obtained content of each webpage with the stored contents of the corresponding webpage; and
determining that the contents of the one or more webpages corresponding to the stored one or more favorite websites have been updated when one or more currently obtained contents of the webpages do not match the stored contents of the corresponding webpage.

18. The non-transitory storage medium as described in claim 13, wherein the method further comprises:
receiving the SMS messages as feedback about the updated contents of the webpages via the second communication unit, and transmitting the received SMS message to the web server via the first communication unit, causing the web server to apply the update to a corresponding webpage.
